(19) United States
(12) Patent Application Publication
(10) Pub. No.: US 2014/0207787 A1
(43) Pub. Date: Jul. 24, 2014

(54) Multi-tenant system for consolidating, searching and sharing distributed user-specific digital content

(71) Applicant: Ajay Vohra, Canton, MI (US)

(72) Inventor: Ajay Vohra, Canton, MI (US)

(73) Assignee: Nubean LLC, Canton, MI (US)

(21) Appl. No.: 13/748,420

(22) Filed: Jan. 23, 2013

(51) Int. Cl. G06F 17/30

(52) U.S. Cl. CPC G06F 17/30321
USPC 707/741

(57) ABSTRACT

This invention is a system for consolidating distributed user-specific digital content, making the content available for search through a user-specific search index, and enabling sharing of selected user-specific digital content with other users through dynamically created ad hoc shared search indexes. The preferred embodiment of this invention is a multi-tenant user subscription based service hosted on the internet. Another embodiment of this invention is a multi-tenant system hosted within an organization.

### CROSS-REFERENCE TO RELATED APPLICATIONS

Provisional Patent Application Number: U.S. Ser. No. 61/590,159

### Filing Date: Jan. 24, 2012

### OTHER REFERENCES

[1] Fay Chang, Jeffrey Dean, Sanjay Ghemawat, Wilson C. Hsieh, Deborah A. Wallach, Mike Burrows, Tushar Chandra, Andrew Fikes, and Robert E. Gruber. Bigtable: A distributed storage system for structured data. In Proceedings of the 7^{th} Conference on USENIX Symposium on Operating Systems Design and Implementation—Volume 7, pages 205-218, 2006.

[2] Giuseppe de Candia, Deniz Hastorun, Madan Jampani, Gunavardhan Kakulapati, Alex Pilchin, Swaminathan Sivasubramanian, Peter Vosshall, and Werner Vogels. Dynamo: Amazon's highly available key-value store. In Proceedings of twenty-first ACM SIGOPS symposium on Operating systems principles, pages 205-220. ACM, 2007.

### STATEMENT REGARDING FEDERALLY SPONSERED RESEARCH OR DEVELOPMENT

Not Applicable.

### BACKGROUND OF THE INVENTION

1. Field of the Invention

This invention belongs to the field of unstructured information storage and retrieval systems. This field includes indexing of unstructured digital content in preparation for searching the content through unstructured search queries.

2. State of Technology

In the current state of technology, a person may have distributed digital content footprint spanning files on multiple user-specific computers, multiple email accounts such as Gmail and Yahoo Mail, social network accounts such as Facebook and Twitter, and cloud application accounts such as Google Docs and You Tube, among other distributed user-specific digital content sources.

Current search engines do not provide the capability for a user to consolidate their distributed user-specific digital content in one logical data store, to make available for search the consolidated user-specific digital content through a user-specific search index, and to make available selected user-specific digital content for search to other selected users through ad hoc shared search indexes.

A need exists for a system that can consolidate unstructured user-specific digital content from distributed user-specific sources in one logical data store, provide user-specific search capability on the consolidated digital content and provide an ability to share selected user-specific digital content with other selected users through ad hoc shared search indexes.

### BRIEF SUMMARY OF THE INVENTION

The system specified in this invention consolidates unstructured user-specific digital content from distributed user-specific sources, provides user-specific search capability on the consolidated digital content and provides an ability to share selected user-specific digital content with other selected users through dynamic ad hoc shared search indexes.

The ad hoc search indexes can be created by any user and other users can be invited to join a shared search index. Any member of a shared search index can share their user-specific digital content into the shared search index and can search the entire shared digital content in a shared search index. Shared search indexes are dynamic in that the life-span of a shared search index, the searchable digital content in a shared search index and user membership of a shared search index can change at any time, and all these aspects are controlled by the original creator and current members of the shared search index.

A new user creates a new account in the system using a unique primary email address. A new user is verified by system through a verification URL sent to the user's primary email address. The user must click the verification URL sent to the user's primary email address for the user to be verified by the system. Once a new user is verified by the system, the user can continually consolidate and search their user-specific digital content in the system.

To consolidate their user-specific digital content in the system, a user can upload files from their user-specific computers to the system using a web browser, use a system provided desktop client that can periodically automatically upload selected desktop files into the system, and add user-specific email, social network and cloud application accounts for automatic periodic consolidation by the system.

A user can search their user-specific search index or search their shared search indexes using a web browser. Search queries can be simple unstructured queries based on keywords, or advanced queries that allow one or more parameters of the query to be controlled by search user. The system returns the search results from the target search index ranked according to relevance and categorized into five segments: Desktop, Web, Email, Social Network and Cloud Application.

The preferred embodiment of this invention is a multi-tenant subscription based service hosted on the internet. In this embodiment, the system services are provided over the internet and the user of the system consumes the services through any device with a web browser. In this embodiment, the system consolidates user-specific digital content of a user by connecting with distributed user specified digital content sources over the internet. A variation of this embodiment would be an advertising based service hosted on the internet.

Another embodiment of this invention is a multi-tenant system hosted within an organization. In this embodiment, the system services are provided over the intranet of the organization and the user of the system consumes the services through any device with a web browser that can access the organization's intranet. In this embodiment, the system consolidates user-specific digital content of a user by connecting with user specified digital content sources available within the intranet, or over the internet.

### BRIEF DESCRIPTION OF THE SEVERAL VIEWS OF THE DRAWING

Below is a listing of the drawings:

FIG. 1 System Architecture: This drawing describes the overall system architecture of the system, showing key components of the system

FIG. 2 New User Use Case: This drawing describes the algorithmic steps related to the use case of a new user registering with the system

FIG. 3 Upload Documents Use Case: This drawing describes the algorithmic steps related to the use case of uploading user-specific documents into the system

FIG. 4 Email Consolidation Use Case: This drawing describes the algorithmic steps related to the use case of a user adding an email account for periodic automatic consolidation of email account contents into the system

FIG. 5 Social Network Consolidation Use Case: This drawing describes the algorithmic steps related to the use case of a user adding a social network account for periodic automatic consolidation of social network account contents into the system

FIG. 6 Cloud Application Consolidation Use Case: This drawing describes the algorithmic steps related to the use case of a user adding a cloud application account for periodic automatic consolidation of cloud application account contents into the system

FIG. 7 Search Index Specific Search: This drawing describes the algorithmic steps related to the use case of a user searching a specific search index

FIG. 8 Share Content Use Case: This drawing describes the algorithmic steps related to the use case of sharing user-specific content stored in the system into a shared search index in the system

### DETAILED DESCRIPTION OF THE INVENTION

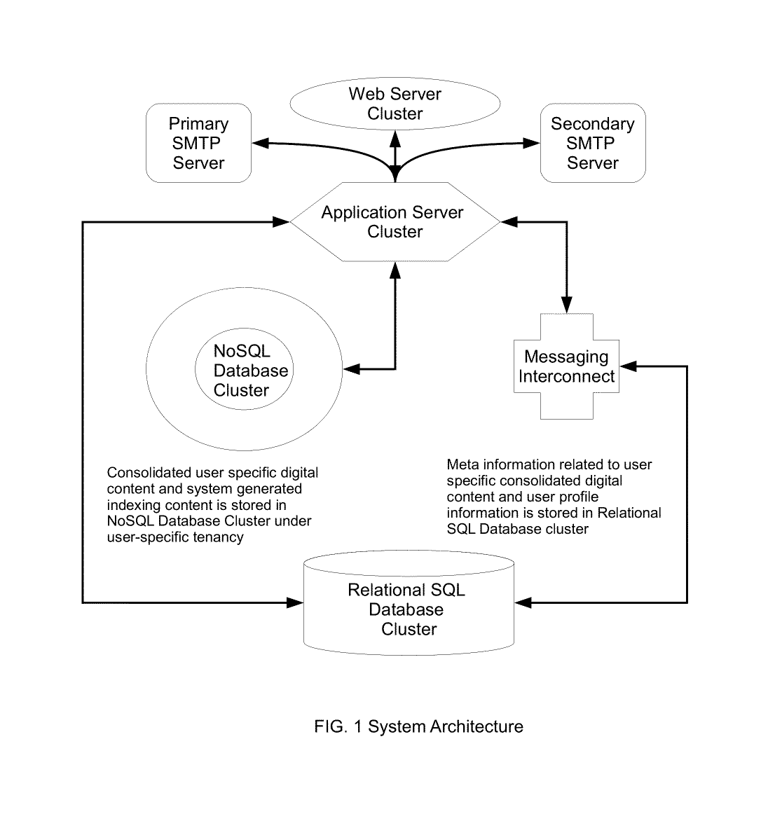

System Architecture The system architecture of this invention is shown in FIG. 1 and comprises of following key elements:
1. At least one cluster of Web Servers that the users of the system interface with in order to consume the web services offered by the system
2. At least one cluster of Application Servers that execute the algorithms required to implement this invention
3. A Primary and Secondary pair of SMTP servers so the system can send email
4. At least one highly available persistent messaging interconnect so various software modules in the system can asynchronously and reliably communicate with each other
5. At least one cluster of highly available relational SQL database for storing meta information related to consolidated user-specific digital content and user profile
6. At least one cluster of highly scalable and highly available distributed data storage system that combines attributes of Bigtable [1] and Dynamo [2] and is henceforth referred to as NoSQL Database Cluster. This NoSQL Database Cluster is used for storing user-specific consolidated digital content and for storing system generated index content related to indexing user-specific digital content for user-specific search index and indexing shared content for ad hoc shared search indexes created within the system

### New User Use Case

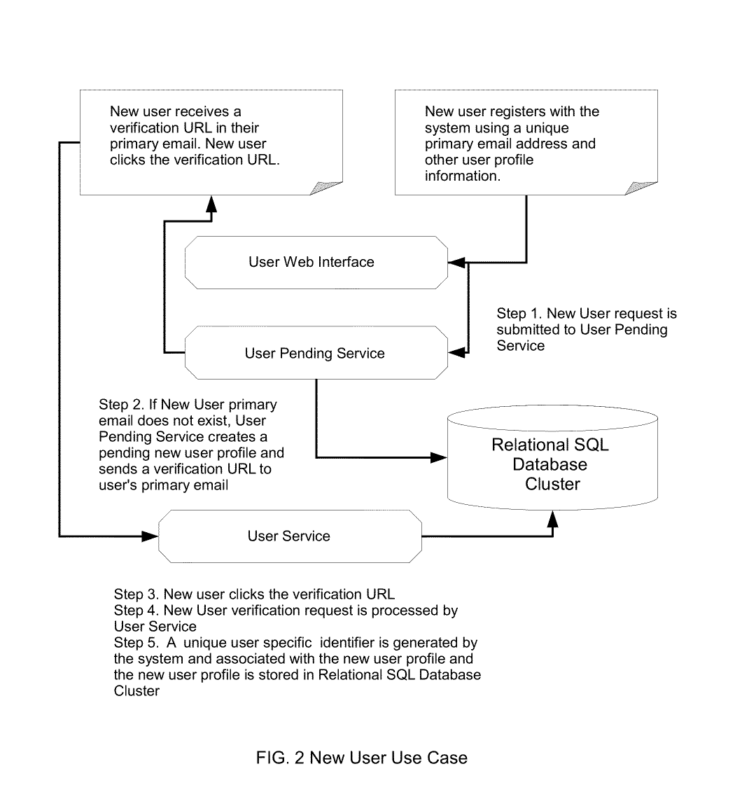

The use case for a new user joining the system is shown in FIG. 2 New User Use Case and comprises of following key steps:
1. New user uses a unique primary email address to register with the system
2. The system sends a verification URL to new user's primary email address
3. After the new user clicks on the verification URL, new user registration is completed in the system and a system generated unique identifier (UUID) is associated with the user profile
   In the embodiment of this invention where the system is offered as a subscription based service hosted in the internet, a new user registration request is intercepted upfront and redirected to a payment system that sets up a new subscription payment profile. The payment system for setting up a new subscription payment profile is outside the scope of this invention.

### Consolidating Distributed User Specific Digital Content

The consolidated user-specific digital content is stored and indexed for search using a method that retains the tenancy information of the user. This method of retaining user-specific tenancy for the consolidated digital content and associated indexing content allows user-specific search indexes to be offered to various users within this multi-tenant system, and it also enables creation of ad hoc shared search indexes. The consolidated user-specific digital content is encrypted in storage. The encryption method allows for mutation of user password.

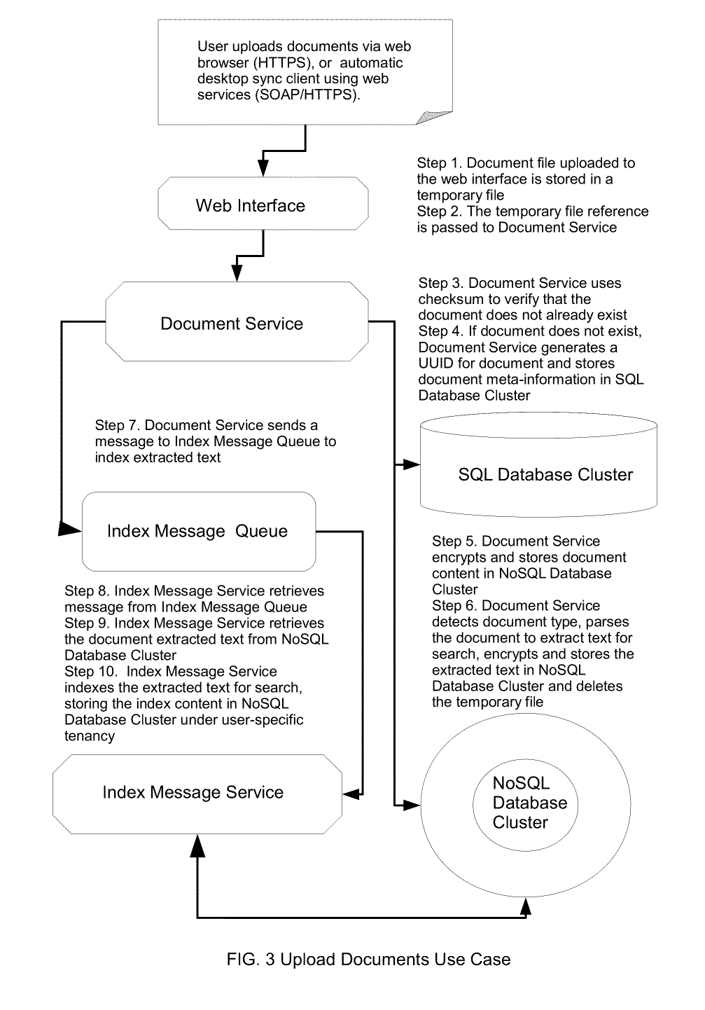

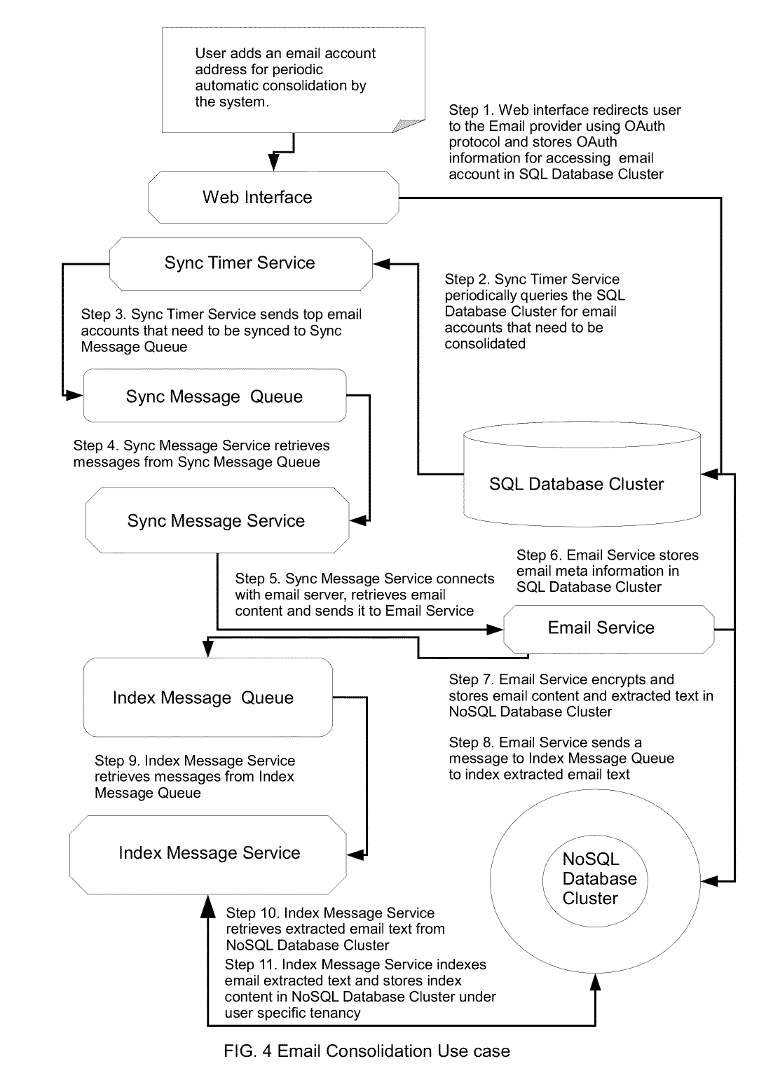

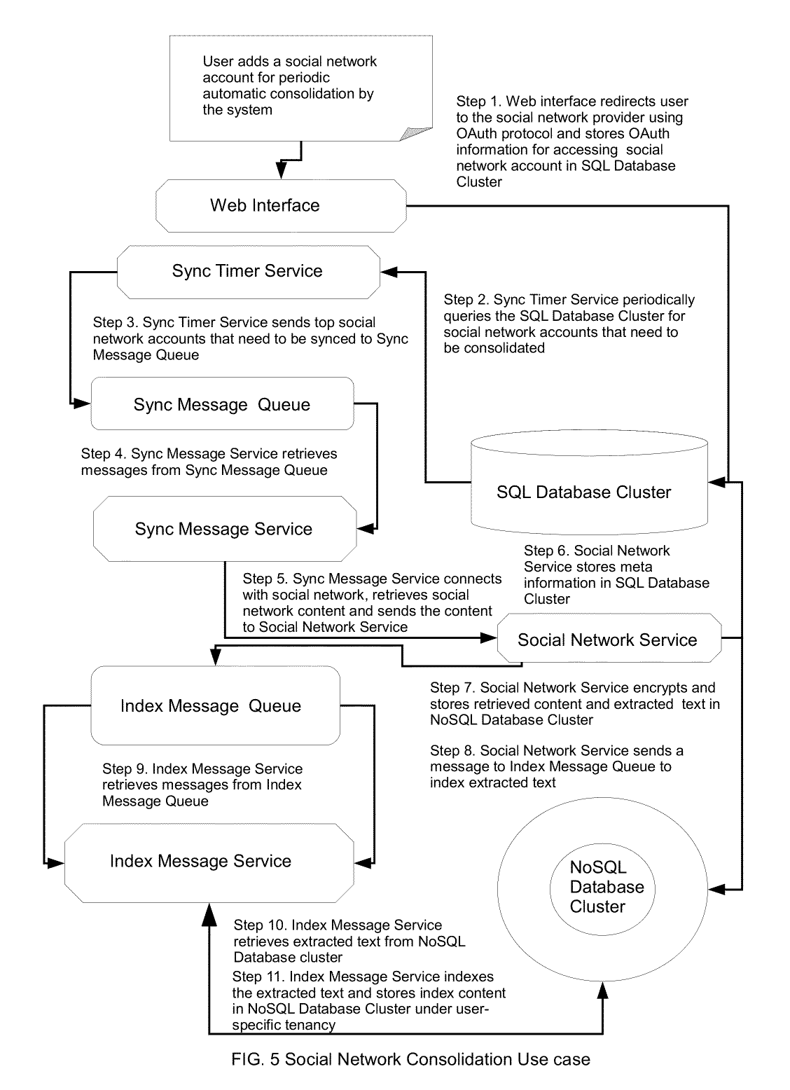

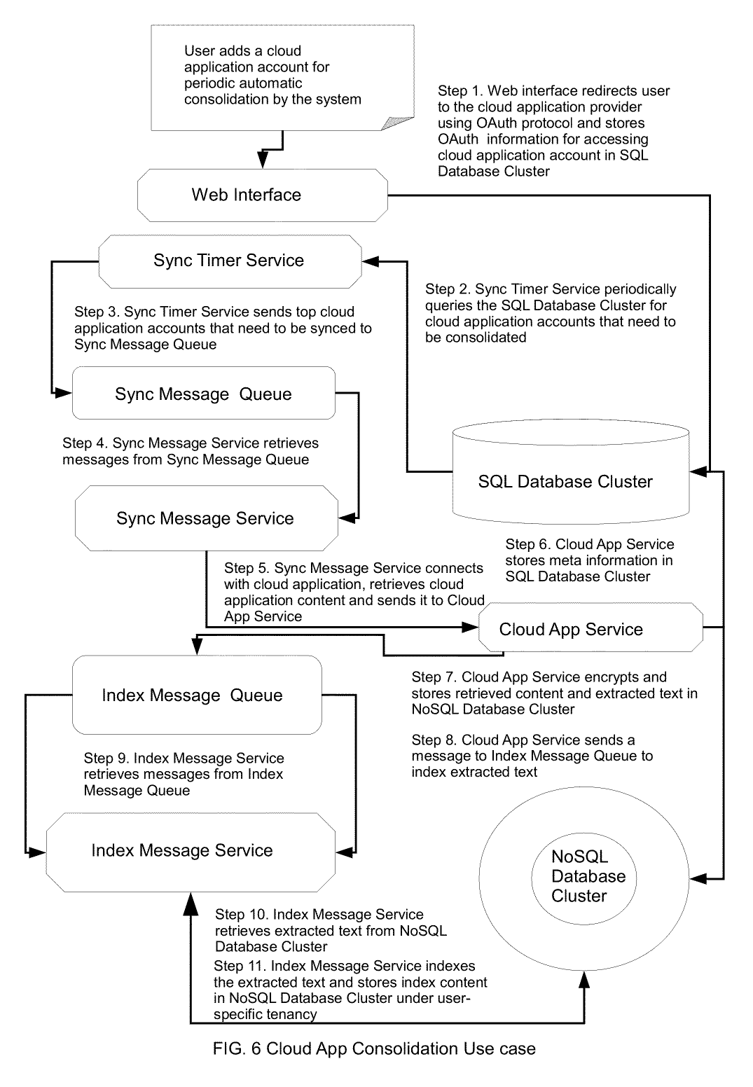

The details of consolidating distributed user-specific digital content from various types of content sources are described below. A user can consolidate their digital content as discussed below:
1. Personal computer files can be uploaded to the system using the method described in FIG. 3 Upload Documents Use Case
2.Email accounts can be added to the system for automatic consolidation using the method described in FIG. 4 Email Consolidation Use Case
3. Social Network accounts can be added to the system for automatic consolidation using the method described in FIG. 5 Social Network Consolidation Use Case
4.Cloud Application accounts can be added to the system for automatic consolidation using the method described in FIG. 6 Cloud Application Consolidation Use Case

### Search Index Specific Search

The consolidated user-specific digital content is indexed into a user-specific search index that can be searched exclusively by the owning user using simple key word search queries submitted to the system through a web browser.

Users can share their user-specific digital content into shared search indexes and search a shared search index using simple key word search queries submitted to the system through a web browser.

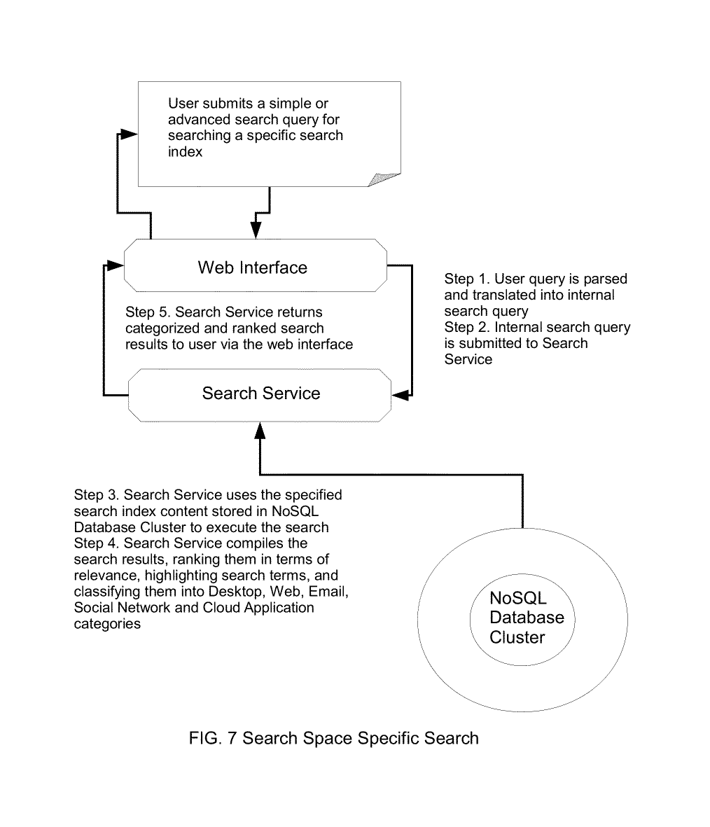

The search index specific query is mapped by the system to search index specific index to execute the search. The results of a search index specific search query are returned to the user whereby the search results are ranked according to relevance and also categorized into Desktop, Web, Email, Social Network, and Cloud Application categories. Search index specific search is described in FIG. 7 Search Index Specific Search.

### AD HOC Shared Search Indexes

The system specifies a method whereby any user in the system can create ad hoc shared search indexes that can be used to share digital content among the members of the shared index.

The user that creates a search index is designated as the owner of the shared search index. The owner of the shared search index is allowed to invite other users to the shared search index by sending an email invitation to other users in the system. Users may choose to accept an invitation to join a shared search index or may decline the invitation.

Any member of a shared index can share their user-specific digital content with a shared search index. When a user shares their digital content into the shared index, the system makes available their shared content for search through the shared search index.

A shared search index owner may remove a member from shared search index. A participating member may remove themselves from a shared search index. Any member of a shared search index may remove their previously shared content from the shared search index. The owner of a shared index may completely remove a shared index, whereby the shared index is no longer available for search by any user.

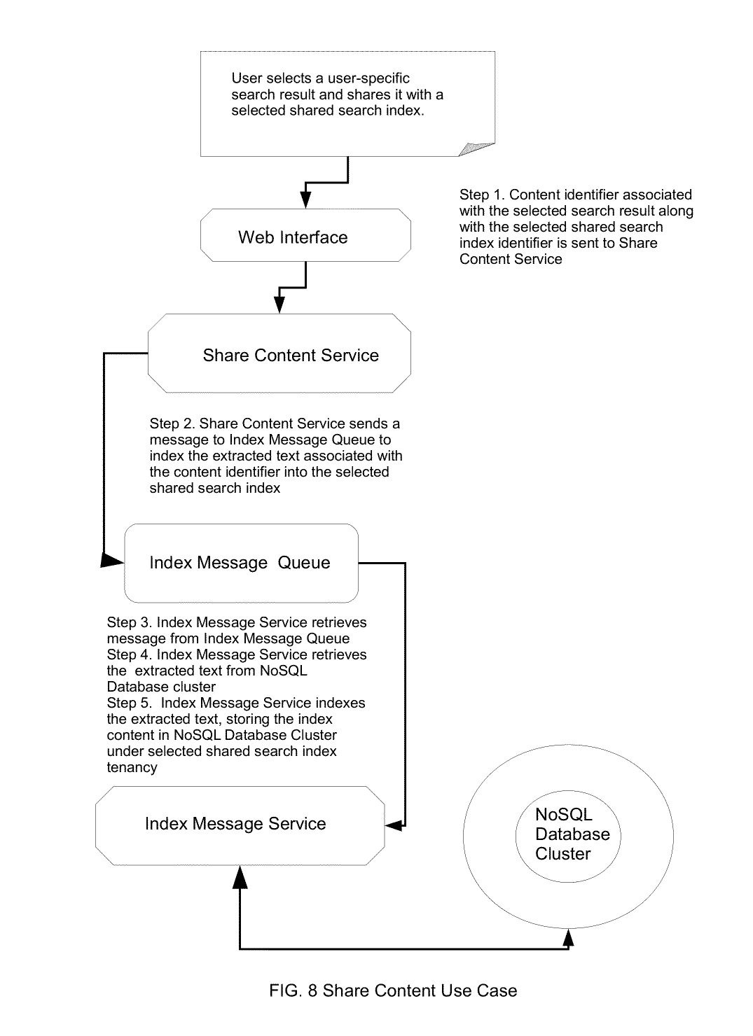

A user shares content with a shared search index via a web browser, as described in FIG. 8 Share Content Use Case.

What is claimed is:

1. A multi-tenant system for delivering user-specific services for: periodically consolidating user-specific digital content from distributed network services into a single logical data store managed by the system while maintaining user-specific tenancy for the consolidated user-specific digital content; indexing of consolidated user-specific digital content into a user-specific search index managed by the system; indexing of shared user-specific digital content into ad hoc shared search indexes managed by the system; performing unstructured search queries in user-specific search index, or in a shared search index, using a remote browser device connected over a network.

2. The system of claim 1 wherein the distributed network services from which user-specific digital content can be periodically consolidated into a single logical store must include at least one distributed network service for each of the following types: internet based email service supporting webmail, POP3 or IMAP protocols; internet based social networking service; internet based cloud application service.

3. The system of claim 2 wherein a user is able to configure a distributed network service for periodic consolidation of user-specific digital content into the system, without specifying to the system any user-specific credentials used by the user to directly logon to the distributed network service.

4. The system of claim 3 wherein the user is able to upload arbitrary content files into the user-specific consolidated digital content using a remote browser device connected over a network.

5. The system of claim 4 wherein a user is able to create one or more shared search indexes, invite other users in the system to have access to a shared search index, remove another user's access to a shared search index owned by the user, select and share user-specific digital content into a shared search index, remove previously shared user-specific digital content from a shared search index, and remove a shared search index owned by the user.

6. The system of claim 5 wherein the user-specific services are offered over the internet as subscription based services.

7. The system of claim 5 wherein the user-specific services are hosted and offered within an organization's intranet.
